(19) United States
(12) Patent Application Publication
(10) Pub. No.: US 2009/0012793 A1
(43) Pub. Date: Jan. 8, 2009

(54) TEXT-TO-SPEECH ASSIST FOR PORTABLE COMMUNICATION DEVICES

(76) Inventors: Quyen C. Dao, Dillsburg, PA (US); Gerard R. Raimondi, Huntersville, NC (US); William D. Reeves, Mechanicsburg, PA (US); Paul L. Snyder, Jerseyville, IL (US)

Correspondence Address: HOFFMAN WARNICK LLC, 75 STATE ST, 14TH FLOOR, ALBANY, NY, 12207, US

(21) Appl. No.: 11/773,123

(22) Filed: Jul. 3, 2007

(51) Int. Cl. G10L 13/08

(52) U.S. Cl. 704/260; 704/E13.002

(57) ABSTRACT

The present invention provides a text-to-speech assist for portable communication devices. A method for communicating text data using a portable communication device in accordance with the present invention includes: displaying text data on a display of the portable communication device while communicating with a party; selecting at least a portion of the displayed text data; converting the selected text data into synthesized speech; and providing the synthesized speech to the party using the portable communication device.

### FIELD OF THE INVENTION

The present invention relates to communication devices, and more specifically relates to a text-to-speech assist for portable communication devices.

### BACKGROUND OF THE INVENTION

A cellular (cell) phone, personal desktop assistant (PDA), walkie-talkie, or other type of portable communication device is typically also a storage facility for text data, such as contacts, phone numbers, addresses, etc. Often, when using a cell phone, the party on the other end of the line will request information, such as someone's phone number, that has been stored by the caller in a text format on the cell phone. In such a case, the following sequence of events could occur:
1) The caller calls a person X using his/her cell phone.
2) While the caller is speaking with person X, person X asks the caller if they have the phone number of a person Y.
3) The caller pulls the cell phone away from his/her ear and mouth, then browses a contacts list stored in the cell phone for person Y.
4) Upon finding an entry for person Y in the contacts list, the caller attempts to quickly memorize the phone number for person Y.
5) The caller places the cell phone back to his/her ear and mouth and attempts to recite the memorized phone number of person Y to person X.

The problem with the above-described scenario is one of inconvenience to the caller. The caller is required to quickly memorize a multi-digit phone number and then repeat the memorized phone number to the other party. This can be difficult, as the caller typically cannot look at the display of the cell phone while speaking into the cell phone. This problem is amplified as the amount of text data that has to be memorized increases (e.g., the address of person Y). Accordingly, there exists a need in the art to overcome the deficiencies and limitations described hereinabove.

### SUMMARY OF THE INVENTION

The present invention relates to a text-to-speech assist for portable communication devices.

In accordance with the present invention, a text-to-speech system is integrated into a portable communication device. During a communication session (e.g., phone call), instead of caller having to memorize and subsequently recite text data stored on the portable communication device to another party, the text-to-speech system reads the text data directly to the other party. This ensures that the text data is recited accurately and efficiently to the other party.

A first aspect of the present invention is directed to a method for communicating text data using a portable communication device, comprising: displaying text data on a display of the portable communication device while communicating with a party; selecting at least a portion of the displayed text data; converting the selected text data into synthesized speech; and providing the synthesized speech to the party using the portable communication device.

A second aspect of the present invention is directed to a system for communicating text data using a portable communication device, comprising: a system for displaying text data on a display of the portable communication device while communicating with a party; a system for selecting at least a portion of the displayed text data; a text-to-speech system for converting the selected text data into synthesized speech; and a system for providing the synthesized speech to the party using the portable communication device.

A third aspect of the present invention is directed to a program product stored on a computer readable medium for communicating text data using a portable communication device, the computer readable medium comprising program code for: displaying text data on a display of the portable communication device while communicating with a party; selecting at least a portion of the displayed text data; converting the selected text data into synthesized speech; and providing the synthesized speech to the party using the portable communication device.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts an illustrative portable communication device in accordance with an embodiment of the present invention.

FIG. 2 depicts a flow diagram of an illustrative process in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As detailed above, in accordance with the present invention, a text-to-speech system is integrated into a portable communication device. During a communication session (e.g., phone call), instead of a caller having to memorize and subsequently recite text data stored on the portable communication device to another party, the text-to-speech system reads the text data directly to the other party. This ensures that the text data is recited accurately and efficiently to the other party.

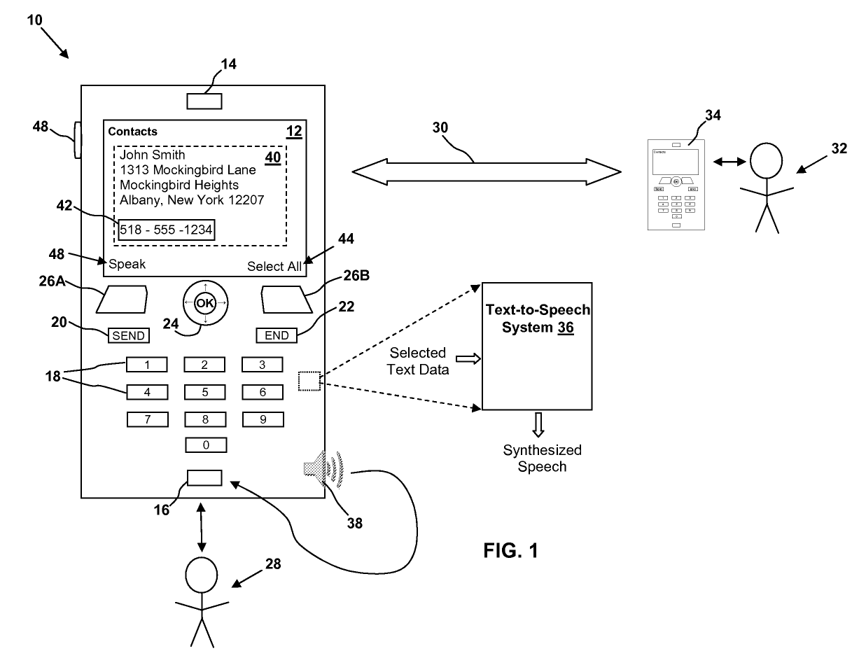

FIG. 1 depicts an illustrative portable communication device 10 in accordance with an embodiment of the present invention. The portable communication device 10, in this example in the form of a cell phone, comprises a display 12, a speaker 14, a microphone 16, a plurality of number keys 18, a send button 20, and an end button 22. Also included are a navigation button 24 and menu select buttons 26A, 26B. These components operate in a known manner to allow a user 28 to communicate 30 (e.g., place/receive a phone call) with a party 32 via another portable communication device 34. Although described as a cell phone, the portable communication device 10 can comprise any now known or later developed device capable of sending/receiving phone calls or other types of audible communication. Further, although a specific configuration of a cell phone is described, many other cell phone configurations are possible.

In accordance with the present invention, the portable communication device 10 is also provided with a text-to-speech system 36 that is configured to read and vocally transfer selected text data displayed on the display 12 to the party 32. The selected text data is synthesized into speech using the text-to-speech system 36. The synthesized speech is output from the portable communication device 10 through a speaker 38 (and/or speaker 14), input back into the portable communication device 10 through the microphone 16, and communicated 30 to the party 32. Such a speaker 38 is commonly available on a portable communication device 10 to allow for speaker-phone operation.

A text-to-speech system is typically composed of two parts: a front-end and a back-end. Broadly, the front-end takes input in the form of text data and outputs a symbolic linguistic representation. The back-end takes the symbolic linguistic representation as input and outputs a synthesized speech waveform.

The front-end of a text-to-speech system generally has two main tasks. First, numbers, abbreviations, etc., in the text data are identified and converted into their written-out word equivalents. This process is commonly termed text normalization, pre-processing, or tokenization. Then, phonetic transcriptions are assigned to each word, and the text is divided and marked into various prosodic units, such as phrases, clauses, and sentences. The process of assigning phonetic transcriptions to words is called text-to-phoneme (TTP) or grapheme-to-phoneme (GTP) conversion. The combination of phonetic transcriptions and prosody information make up the symbolic linguistic representation output of the front end.

The back-end of a text-to-speech system takes the symbolic linguistic representation and converts it into actual sound output. The back end is often referred to as a speech synthesizer.

Naturalness and intelligibility are two of the characteristics used to describe the quality of a speech synthesizer. The naturalness of a speech synthesizer refers to how much the output sounds like the speech of a real person. The intelligibility of a speech synthesizer refers to how easily the output can be understood. The ideal speech synthesizer is both natural and intelligible, and each of the different synthesis technologies tries to maximize both of these characteristics. There are many technologies available for generating synthetic speech waveforms, including concatenative synthesis (the concatenation (or stringing together) of segments of recorded speech) and formant synthesis (synthesized speech is created using an acoustic model).

Any suitable now known or later developed text-to-speech system can be used to implement the text-to-speech system 36 in the portable communication device 10 of the present invention. The text-to-speech system 36 can be implemented in software, hardware (e.g., an integrated circuit), or a combination of both.

In accordance with an embodiment of the present invention, when the party 32 requests information, such as someone's phone number, that has been stored by the caller 28 in a text format on the portable communication device 10, the following illustrative sequence of events can occur:

(A) The caller 28 calls the party 32 using his/her portable communication device 10 to establish a communication session.

(B) While the caller 28 is speaking with the party 32, the party 32 asks the caller 28 if they have the phone number of a person Z.

(C) The caller 28 pulls the portable communication device 10 away from his/her ear and mouth, then browses a contacts list stored in the portable communication device 10 for the person Z. This can be done, for example, using the navigation button 24 and menu select buttons 26A, 26B, or in any other suitable manner. In general, the methodology for locating a contact is dependent on the configuration of the portable communication device that is being used.

(D) Upon finding an entry 40 for person Z in the contacts list, the caller 28 selects at least a portion of the text data in the entry 40 shown on the display 12. The selected text data will subsequently be read to the party 32 using the text-to-speech system 36 as described below. For example, as depicted in FIG. 1, the caller 28 can navigate to and select a given field 42 (e.g., phone number) in the entry 40 for person Z shown on the display 12 using the navigation button 24. Further, if the caller 28 desires to select all of the text data corresponding to the person Z, a “Select All” command 44 or the like can be selected using the menu select button 26B. Many other techniques for selecting text data on the display 12 are also possible, and the above examples are not intended to be limiting.

(E) After the caller 28 has selected some or all of the text data in the entry 40 for person Z shown on the display 12, the caller 28 initiates the reading of the selected text data to the party 32 by the text-to-speech system 36. This process can be initiated in a variety of ways including, for example, by actuating a button, key, or key sequence, using a voice command, etc. The portable communication device 10 depicted in FIG. 1 includes a “Speak” command 46 that can be selected using the menu select button 26A to initiate the reading of the selected text data to the party 32. In addition, the portable communication device 10 includes a “Speak” button 48, which when actuated by the caller 28, initiates the reading of the selected text data to the party 32.

(F) The text-to-speech system 36 then operates to convert the selected text data to synthesized speech, which is then output from the portable communication device 10 through the speaker 38 (and/or speaker 14), input back into the portable communication device 10 through the microphone 16, and communicated 30 to the party 32. In this way, the selected text is read directly to the party 32. If the selected text data corresponds to a phone number, for example, the text-to-speech system 36 can be configured to output the following synthesized speech: “John Smith's phone number is 518-555-1234,” or more simply, “518-555-1234.”

(G) The caller 28 then places the portable communication device 10 back to his/her ear and continues speaking with the party 32.

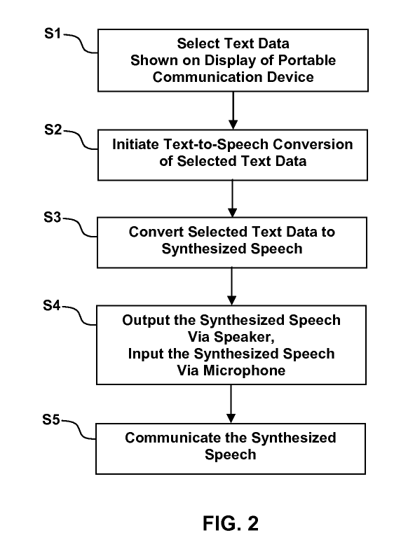

FIG. 2 depicts a flow diagram of an illustrative process in accordance with an embodiment of the present invention. The process is described below with reference to FIG. 1. In step S1, a caller 28 selects text data shown on the display 12 of the portable communication device 10. In step S2, the caller 28 initiates a text-to-speech conversion of the selected text data into synthesized speech. In step S3, the selected text data is converted into synthesized speech by the text-to-speech system 36. In step S4, the synthesized speech generated by the text-to-speech system 36 is output from the portable communication device 10 through the speaker 38 (and/or speaker 14), and then input back into the portable communication device 10 through the microphone 16. In step S5, the synthesized speech input by the microphone 16 of the portable communication device 10 is communicated to the party 32.

It should be noted that the party 32, if he/she also has a portable communication device 10 in accordance with the present invention, can also communicate synthesized speech to the caller 28 in manner similar to that described above. As such, synthesized speech can be communicated from the caller 28 to the party 32 and/or from the party 32 to the caller 28.

Some/all aspects of the present invention can be provided on a computer-readable medium that includes computer program code for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture (e.g., a compact disc, a magnetic disk, a tape, etc.), on one or more data storage portions of a computer system, such as memory and/or a storage system (e.g., a fixed disk, a read-only memory, a random access memory, a cache memory, etc.), and/or as a data signal traveling over a network (e.g., during a wired/wireless electronic distribution of the computer program code).

As used herein, the term “computer program code” refers to any expression, in any language, code or notation, of a set of instructions intended to cause a computer system having an information processing capability to perform a particular function either directly or after either or both of the following: (a) conversion to another language, code or notation; and (b) reproduction in a different material form. The computer program code can be embodied as one or more types of computer program products, such as an application/software program, component software/library of functions, an operating system, a basic I/O system/driver for a particular computing and/or I/O device, and the like.

It should be appreciated that the teachings of the present invention could be offered as a business method on a subscription or fee basis. For example, a service provider (e.g., a provider of cell phone service) can create, maintain, enable, and deploy a text-to-speech assist for portable communication devices, as described above.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for communicating text data using a portable communication device, comprising:
displaying text data on a display of the portable communication device while communicating with a party;
selecting at least a portion of the displayed text data;
converting the selected text data into synthesized speech; and
providing the synthesized speech to the party using the portable communication device.

2. The method of claim 1, further comprising:
initiating a conversion of the selected text data into synthesized speech.

3. The method of claim 1, wherein providing the synthesized speech to the party using the portable communication device further comprises:
outputting the synthesized speech from the portable communication system through a speaker; and
inputting the synthesized speech output by the speaker into the portable communication system through a microphone.

4. The method of claim 1, wherein the text data comprises contact information.

5. The method of claim 4, wherein the contact information comprises a telephone number.

6. A system for communicating text data using a portable communication device, comprising:
a system for displaying text data on a display of the portable communication device while communicating with a party;
a system for selecting at least a portion of the displayed text data;
a text-to-speech system for converting the selected text data into synthesized speech; and
a system for providing the synthesized speech to the party using the portable communication device.

7. The system of claim 6, further comprising:
a system for initiating a conversion of the selected text data into synthesized speech.

8. The system of claim 6, wherein the system for providing the synthesized speech to the party using the portable communication device further comprises:
a speaker for outputting the synthesized speech from the portable communication system; and
a microphone for inputting the synthesized speech output by the speaker into the portable communication system.

9. The system of claim 6, wherein the text data comprises contact information.

10. The system of claim 9, wherein the contact information comprises a telephone number.

11. A program product stored on a computer readable medium for communicating text data using a portable communication device, the computer readable medium comprising program code for:
displaying text data on a display of the portable communication device while communicating with a party;
selecting at least a portion of the displayed text data;
converting the selected text data into synthesized speech; and
providing the synthesized speech to the party using the portable communication device.

12. The program product of claim 11, further comprising program code for:
initiating a conversion of the selected text data into synthesized speech.

13. The program product of claim 11, wherein the program code for providing the synthesized speech to the party using the portable communication device further comprises program code for:
outputting the synthesized speech from the portable communication system through a speaker; and
inputting the synthesized speech output by the speaker into the portable communication system through a microphone.

14. The program product of claim 11, wherein the text data comprises contact information.

15. The program product of claim 14, wherein the contact information comprises a telephone number.
